(19) United States
(12) Patent Application Publication
(10) Pub. No.: US 2023/0041823 A1
(43) Pub. Date: Feb. 9, 2023

(54) Mobile Jack Rack

(71) Applicant: Versatile Products, Inc., Lafayette, LA (US)

(72) Inventor: Michael Munro, Lafayette, LA (US)

(73) Assignee: Versatile Products, Inc., Lafayette, LA (US)

(21) Appl. No.: 17/395,701

(22) Filed: Aug. 6, 2021

(51) Int. Cl. B66F 5/02; B60R 9/06; B66F 13/00

(52) U.S. Cl. CPC B66F 5/02; B60R 9/06; B66F 13/00

(57) ABSTRACT

An article of manufacture for providing a mobile jack rack supporting a plurality of uses is disclosed. The mobile jack rack has a tow bar for coupling to a vehicle trailer towing receiver, an upper support platform having a front side coupled to the tow bar and a plurality of sliding support flanges coupled to an upper side, a manual scissor jack coupled to an underside of the upper support platform, the manual scissor jack having a manual hand crank, a lower support base having a top side coupled to an opposite side of the manual scissor jack, a steering bar hinge coupled between the manual hand crank and the manual scissor jack to position the manual hand crank in an orientation allowing the manual hand crank to be used as a steering bar, a plurality of locking wheels coupled to an underside of the lower support platform, and a component coupled to the plurality of support flanges.

### TECHNICAL FIELD

This application relates in general to an article of manufacture for providing vehicle towing devices, and more specifically, to an article of manufacture for providing a mobile jack rack supporting a plurality of uses.

### BACKGROUND

Not everyone has a pickup truck and/or a trailer, although most everyone has occasions that require the moving of larger items and/or equipment, or the moving of items that are dirty and/or greasy or the like, but many people have cars and/or SUVs that normally are not suitable to carry larger, dirty, greasy items inside of, and some of those people have the occasions to move or transport those items.

Since most cars and SUVs already have trailer hitches, or can easily have one installed, by virtue of this new apparatus, within certain weight restrictions of the Class of Vehicle and Carrying Weight and Towing Weight of the Class of Hitch, a regular car or SUV can transport many different items and/or different pieces of equipment using the hitch receiver on the vehicle (“RECEIVER”).

Therefore, a need exists for an article of manufacture for providing a mobile jack rack supporting a plurality of uses. The present invention attempts to address the limitations and deficiencies in prior solutions according to the principles and example embodiments disclosed herein.

### SUMMARY

In accordance with the present invention, the above and other problems are solved by providing an article of manufacture for providing a mobile jack rack supporting a plurality of uses according to the principles and example embodiments disclosed herein.

In one embodiment, the present invention is an article of manufacture for providing a mobile jack rack supporting a plurality of uses. The mobile jack rack has a tow bar for coupling to a vehicle trailer towing receiver, an upper support platform having a front side coupled to the tow bar and a plurality of sliding support flanges coupled to an upper side, a manual scissor jack coupled to an underside of the upper support platform, the manual scissor jack having a manual hand crank, a lower support base having a top side coupled to an opposite side of the manual scissor jack, a steering bar hinge coupled between the manual hand crank and the manual scissor jack to position the manual hand crank in an orientation allowing the manual hand crank to be used as a steering bar, a plurality of locking wheels coupled to an underside of the lower support platform, and a component coupled to the plurality of support flanges.

In another aspect of the present invention, the plurality of locking wheels comprise one of the following: rubber tires and swiveling wheels.

In another aspect of the present invention, the manual hand crank further adjusts a position of the lower support base within a perimeter of inches.

In another aspect of the present invention, the component comprises one or more of the following: a generator, a toolbox, a pressure washer, tailgating aid equipment, boiler/cooker, appliances, entertainment equipment, and safety equipment.

In another aspect of the present invention, the mobile jack rack further comprises a mobile jack rack receiver coupled to a back side of the lower support platform for accepting a tow bar attached to an additional trailerable device.

In another aspect of the present invention, the tailgating equipment comprises one or more of the following: gas and/or charcoal BBQ pits, electric and/or gas boilers, and cookers.

In another aspect of the present invention, the appliances comprise one or more of the following: electric and/or gas appliances such as ovens, microwaves, refrigerators, and freezers.

In another aspect of the present invention, the entertainment equipment comprises one or more of the following: TVs, DVDs, game machines, and streaming media players.

In another aspect of the present invention, the upper support platform further comprises a tow receiver for accepting a tow bar from another trailer.

In another aspect of the present invention, the safety equipment comprises one or more of the following: a 4 sided LED scrolling reader board, a single arm hoist, a system mobile generator, a system mobile power supply, a system emergency road package.

In another aspect of the present invention, the system mobile power supply comprises one or more of the following: solar panels, battery packs, AC chargers, battery chargers, lighting, and receptacles.

In another aspect of the present invention, the system emergency road package comprises one or more of the following: an air compressor, a battery charger, a floor jack, a small toolbox, a winch, an LED scrolling sign, an LED flashing light stand.

In another aspect of the present invention, the component further comprises a system dump bin. The system dump bin comprises a storage bin having a bin floor and an opening front flap and a bin dumping lifter for raising and tilting the storage bin for emptying contents.

In another aspect of the present invention, the bin dumping lifter comprises a manual lifter and a hydraulic lifter.

The foregoing has outlined rather broadly the features and technical advantages of the present invention in order that the detailed description of the invention that follows may be better understood. Additional features and advantages of the invention will be described hereinafter that form the subject of the claims of the invention.

It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

Referring now to the drawings in which like reference numbers represent corresponding parts throughout:

FIG. 1 illustrates a rear view of an article of manufacture for providing a mobile jack rack supporting a plurality of uses according to the present invention.

FIG. 2 illustrates a perspective view of an article of manufacture for providing a mobile jack rack supporting a plurality of uses according to the present invention.

FIG. 3 illustrates a perspective view of the present invention and an example layout.

FIG. 4 illustrates a perspective view of one embodiment of an article of manufacture for providing a mobile jack rack in a closed position according to the present invention.

FIGS. 5a-b illustrate an example use as a mobile tool chest for an article of manufacture for providing a mobile jack rack supporting a plurality of uses according to the present invention, and a set of drawers or storage area for peripherals of components of the mobile jack rack.

FIG. 6 illustrates a block diagram of a front view of a use of an article of manufacture for providing a mobile jack rack used as a collapsible BBQ pit and smoker in an open operating position according to the present invention.

FIG. 7 illustrates block diagram of an inside view of an article of manufacture for providing a mobile jack rack used as a collapsible BBQ pit and smoker in a collapsed position according to the present invention.

FIG. 8 illustrates block diagram of a rear view of an article of manufacture for providing a mobile jack rack used as a tailgating, collapsible BBQ pit and smoker in a collapsed position having hanging hooks according to the present invention.

FIG. 9 illustrates block diagram of a side view of an article of manufacture for providing a mobile jack rack used as a collapsible BBQ pit and smoker with a propane tank according to the present invention.

FIG. 10 illustrates block diagram of an article of manufacture for providing a mobile jack rack used as a tailgating boiler, pot, cooktop, light, wind shield, and hoist according to the present invention.

FIG. 11 illustrates block diagram of a side view of an article of manufacture for providing a mobile jack rack used as a tailgating boiler, pot, cooktop, light, wind shield, and hoist according to the present invention.

FIG. 12 illustrates block diagram of a top view of an article of manufacture for providing a mobile jack rack used as a combination BBQ pit, boiler, pot, cooktop, lights, heat shields, and hoist according to the present invention.

FIG. 13 illustrates block diagram of an inside view of an article of manufacture for providing a mobile jack rack used as the BBQ pit section of a combination BBQ pit, boiler, pot, cooktop, and hoist according to the present invention.

FIG. 14 illustrates block diagram of a side view of an article of manufacture for providing a mobile jack rack used as the boiler, pot, cooktop, light, and hoist of a combination BBQ pit, boiler, pot, cooktop, and hoist according to the present invention.

FIG. 15 illustrates block diagram of an article of manufacture for providing a mobile jack rack used as a system cooking rack with interchangeable components according to the present invention.

FIG. 16 illustrates block diagram of an article of manufacture for providing a mobile jack rack used as one embodiment of a system cooking rack with interchangeable components according to the present invention.

FIG. 17 illustrates block diagram of an article of manufacture for providing a mobile jack rack used as another embodiment of a system cooking rack with interchangeable components according to the present invention.

FIG. 18 illustrates block diagram of an article of manufacture for providing a mobile jack rack used as yet another embodiment of a system cooking rack with interchangeable components according to the present invention.

FIG. 19 illustrates block diagram of top view of an article of manufacture for providing a mobile jack rack used as another embodiment of a system cooking rack with interchangeable components according to the present invention.

FIG. 20 illustrates block diagram of a front view of an article of manufacture for providing a mobile jack rack used as another embodiment of a system cooking rack with interchangeable components according to the present invention.

FIG. 21 illustrates block diagram of an article of manufacture for providing a mobile jack rack used as a system entertainment center according to the present invention.

FIG. 22 illustrates block diagram of an article of manufacture for providing a mobile jack rack used as system mobile travel center according to the present invention.

FIG. 23 illustrates block diagram of side view and top view of an article of manufacture for providing a mobile jack rack used as a 4 sided, rotating, LED scrolling reader board according to the present invention.

FIG. 24 illustrates block diagram of a side view of an article of manufacture for providing a mobile jack rack used as system portable, folding, adjustable single arm hoist according to the present invention.

FIG. 25 illustrates block diagram of a front and a side view of an article of manufacture for providing a mobile jack rack used as system hydraulic/manual dump bin according to the present invention.

FIG. 26 illustrates block diagram of a front and a side view of an article of manufacture for providing a mobile jack rack used as system mobile toolbox according to the present invention

FIG. 27 illustrates block diagram of a front and view of an article of manufacture for providing a mobile jack rack used as system emergency road package according to the present invention.

FIG. 28 illustrates block diagram of a front and a side view of an article of manufacture for providing a mobile jack rack used as system mobile generator according to the present invention.

FIG. 29 illustrates block diagram of a front and a side view of an article of manufacture for providing a mobile jack rack used as system mobile pressure washer according to the present invention.

FIG. 30 illustrates block diagram of a front view of an article of manufacture for providing a mobile jack rack used as mobile power supply according to the present invention.

### DETAILED DESCRIPTION

This application relates in general an article of manufacture for providing vehicle towing devices, and more specifically, to an article of manufacture for providing a mobile jack rack supporting a plurality of uses according to the present invention.

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In describing embodiments of the present invention, the following terminology will be used. The singular forms “a,” “an,” and “the” include plural referents unless the context clearly dictates otherwise. As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. As used herein, the singular forms “a,” “an,” and “the” are intended to include the plural forms as well, unless the context clearly indicates otherwise.

It further will be understood that the terms “comprises,” “comprising,” “includes,” and “including” specify the presence of stated features, steps, or components, but do not preclude the presence or addition of one or more other features, steps, or components. It also should be noted that in some alternative implementations, the functions and acts noted may occur out of the order noted in the figures. For example, two figures shown in succession may in fact be executed substantially concurrently or may sometimes be executed in the reverse order, depending upon the functionality and acts involved.

The terms “individual,” and “user” refer to an entity, e.g., a human, using an article of manufacture for providing a mobile jack rack supporting a plurality of uses associated with the invention. The term user herein refers to one or more users.

The term “invention” or “present invention” refers to the invention being applied for via the patent application with the title “Mobile Jack Rack”. Invention may be used interchangeably with Rack.

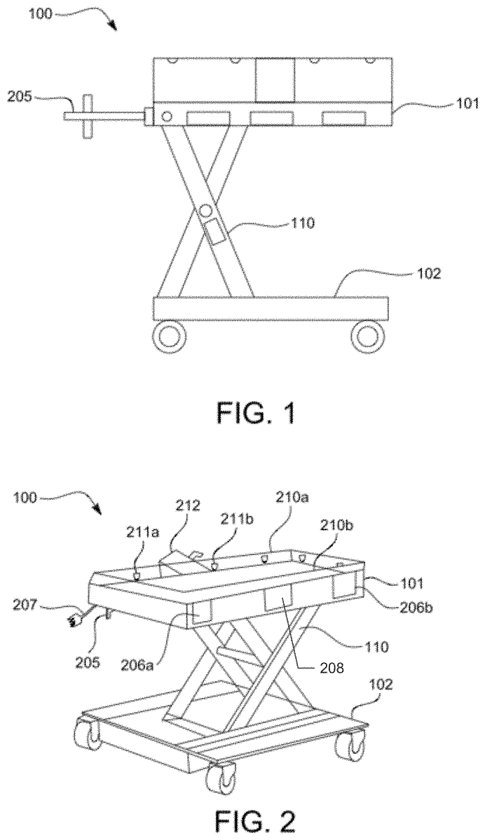

In general, the present disclosure relates an article of manufacture for providing a mobile jack rack supporting a plurality of uses according to the present invention. To better understand the present invention, FIG. 1 illustrates a rear view of an article of manufacture for providing a mobile jack rack supporting a plurality of uses according to the present invention. This new apparatus is a specialized rack with a custom bar (“custom bar”) that inserts into a vehicle's trailer towing receiver (“receiver”), said specialized rack has an upper support platform 101 (“upper support platform”) designed to have either custom and/or generic items and/or equipment, herein referred to as (“components”) (said components further described below), installed on said upper platform 101. By virtue of slide out support flanges 210a-b on both sides of said upper platform, tie down loops, or proprietary connectors, said components can be situated and attached to said upper platform temporarily or permanently, and for awkward, heavy, or unbalanced components, said custom tow bar 212, optionally has flanges on both sides 211a and 211b that slide over the vehicle receiver's hook flanges, and bolt down with a special nut and bolt to give additional balance and support. The rear side of said upper platform has taillights 206a-b and a receiver 208 for a standard tow bar of a boat, rack or whatever to be inserted into to pull said boat or insert said rack or whatever. Attached underneath said upper platform, is a manual, hand cranked scissor jack 110 (“scissor jack”) that is attached to a lower support base 102 that has either locking, swiveling wheels or rubber tires for all terrain movement underneath for easy mobility (“lower support base 102”). Said lower support base 102 is lowered and/or raised within a perimeter of inches by turning the manual hand crank 205 (“hand crank”) of said scissor jack, the complete apparatus herein referred to as the (“mobile jack rack 100”).

When said lower support base 102 is in the lowered, open, position, the locking, swiveling wheels or rubber tires underneath are situated on the ground or other surface enabling movement of any component to anywhere once detached from the vehicle's receiver. Said hand crank 205 on the upper support platform 101, moves up and down on a steering bar hinge so that said hand crank 205 can also be used as the pulling, steering bar (“steering bar”) to guide said mobile jack rack when pulling or pushing it around.

Components that may be situated on said upper support platform 101 include, but are not limited to, items such as BBQ pits, boilers, cookers, generators, pressure washers, toolboxes, entertainment systems, and the like, and can be situated on top of said mobile jack rack 100, and temporarily secured with tie downs and the like, or permanently secured with customized latches. The mobile jack rack 100 can hold and support any item whatsoever that fits within the certain weight restrictions of the particular vehicle, and the certain weight carrying and towing restrictions of the certain class of hitch receiver on said particular vehicle, which in most cases ranges from 300 pounds to 1100 pounds or more. To put into perspective, a full-sized BBQ pit and smoker with a stand and wheels usually weighs less than 200 pounds, and the top cooking section without the stand and wheels could be around 130 pounds or so. This arrangement leaves a lot of open weight room for propane bottles or accessories and the like that will also be situated on said mobile jack rack with certain components such as said BBQ Pit.

The advantage of the mobile jack rack 100 is that, within weight restrictions, a user is able to turn any typical, stationary item, into an easily mobile item that can be transported anywhere, then used, in most cases while still attached to the vehicle, or detached and moved around very easily for independent use, then re-attached to the vehicle receiver, and returned to its original location with ease.

Examples of this would be the case of say, a Generator, a Tool Box, a Pressure Washer, or a BBQ Pit, all components that are usually on a patio or in a storeroom, that would not normally be able to be moved to the park or any other location for use without the use of a trailer or truck bed and the help from another party now become mobile, so, having a typical car or SUV with a receiver, all of the aforesaid components become mobile by use of the mobile jack rack. These items are disclosed in more detail below.

The components can be temporarily or permanently installed onto the upper platform, and still be kept on the patio or in a storeroom as usual for normal home use while sitting on the mobile jack rack in the open position, but when the need to move said components to the park or other location for use, said components are rolled on top of the mobile jack rack 100 to the rear of a vehicle with a trailer hitch, then the mobile jack rack's tow bar 212 is inserted into the vehicle receiver and pinned in place. By cranking said scissor jack 110 to the closed position, which lifts the lower support base 102 with the wheels up to meet the upper support platform 101, makes the mobile jack rack 100 ready for transport. When the destination is reached, the scissor jack 110 is then cranked to the open position, setting the lower support base 102 with locking, swiveling wheels or rubber tires back onto the ground or other surface, so that the mobile jack rack 100 can then be unpinned from the receiver and removed from the vehicle receiver, and said components can then be moved by pushing or pulling and steering said mobile jack rack all around on its wheels. Most components can be used while still attached to said vehicle, including BBQ pits and the like, by virtue of proprietary heat shields. Said mobile jack rack 100, with its tail lights 206a-b powered by the trailer hitch light plug 207, or proprietary splitter plug described in other writings, optionally has an extra heavy duty frame, that also has a built-in receiver 208 in its tail end (“mobile jack rack receiver”) so that while said mobile jack rack 100 is attached to a vehicle receiver, any other tow bar, with or without a hitch ball to pull a trailer, can be inserted into the rear of the mobile jack rack where it's receiver is located, then used to pull a trailer, or to receive the accessory tow bar, or any other type of rack, within weight restrictions.

FIG. 2 illustrates a perspective view of an article of manufacture for providing a mobile jack rack supporting a plurality of uses according to the present invention. In this view, taillights 206a-b may be seen along the upper support base with a receiver 208. A tow bar 212 is shown on an opposite side of the upper support base along with a light plug 207 to connect the taillights 206a-b to a towing vehicle. The upper support platform 101 may include a plurality of attachment holes about its upper surface and walls to allow various components to be coupled to the mobile jack rack 100 securely for transport and use.

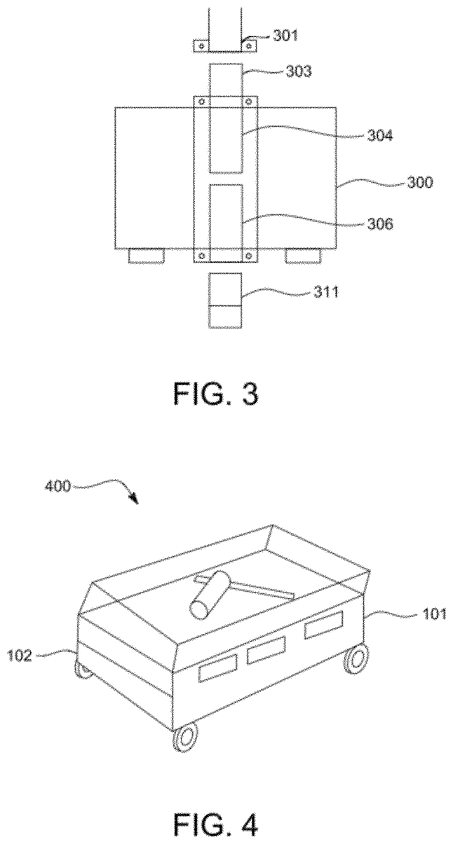

FIG. 3 illustrates a perspective top view of one embodiment of an article of manufacture for providing a mobile jack rack in a closed position without any component according to the present invention. A vehicle receiver 301 is shown ready to accept a mobile jack rack's tow bar or tongue 303 that is coupled to a heavy-duty frame element on a first side 304 of the upper support platform 300. A mobile jack receiver 306 is coupled to the heavy-duty frame element on a second side 306 of the upper support platform 300. A tow bar with a ball hitch 311 may be inserted into the mobile jack receiver 306 and secured to allow other items such as a boat or whatever to be towed at the same time.

FIG. 4 illustrates a rear view of an article of manufacture for providing a mobile jack rack supporting a plurality of uses according to the present invention. When in the closed position 400, the upper support platform 101 rests on top of the lower support base 102. The scissor jack 110 is collapsed to lower the upper support platform 101 onto the lower support base 102, or to lift the lower support base 102 up to the upper support platform 101 as needed.

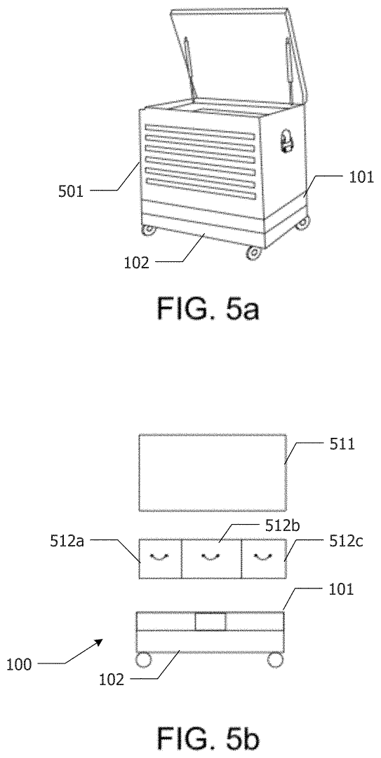

FIG. 5a illustrates an example use as a mobile tool chest 501 for an article of manufacture for providing a mobile jack rack supporting a plurality of uses according to the present invention. Similarly, FIG. 5b illustrates an example use as a storage bin 512 without drawers, or with drawers 512a-c, for an article of manufacture for providing a mobile jack rack supporting a plurality of uses according to the present invention.

A storage bin (“storage bin”) 512 with or without multiple drawers 512a-c that sits on top of the mobile jack rack 100, underneath any equipment component 511 such as a generator, pressure washer, BBQ pit or the like, designed to hold the peripheral items related to said equipment component such as oil filters, utensils, and the like. The storage bin 512 connects to the mobile jack rack 100, and it has connectors of strapping loops for securing said equipment component to said storage bin or can be custom built permanently onto a mobile jack rack.

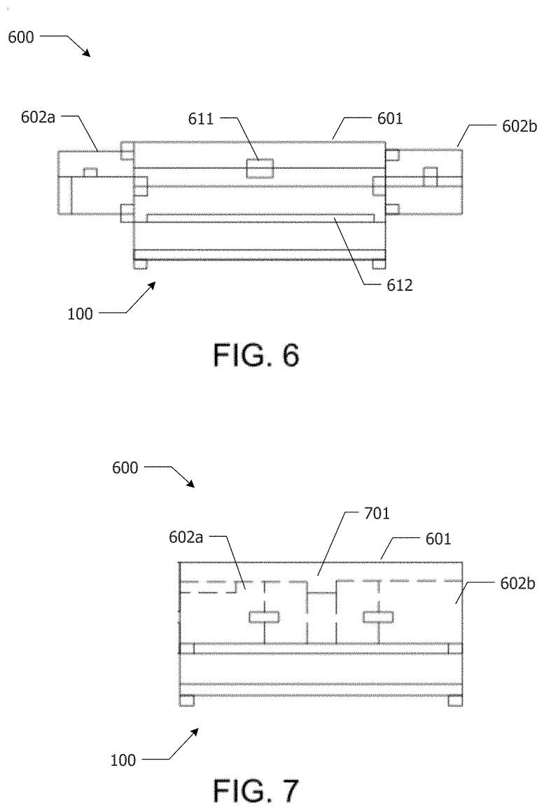

FIGS. 6-20 illustrate block diagrams of a use of an article of manufacture for providing a mobile jack rack used as a tailgating aid according to the present invention. FIG. 6 illustrates a block diagram of a front view of a use of an article of manufacture for providing a mobile jack rack 100 featuring a collapsible BBQ pit and smoker 600 in its open and ready to use state, with its smoker and pit extension 602a-b attached according to the present invention. The collapsible BBQ pit and smoker 601 includes a cover handle 611 that allows a user to open the collapsible BBQ pit and smoker 601 for use in cooking over propane or charcoal grids 612. Tailgating is very popular today. Pro, college, high school, and even little league sports, from football, baseball to all other sports have avid tailgating fans. Even political, festival and party events have a need for tailgating events.

Most of the time tailgating needs a truck and/or a trailer to haul necessary items for a successful event. Tailgating items usually include cooking items, sitting and relaxing items, tools, and entertainment items. Depending on the Class of Vehicle and the Class of Hitch, determines the amount of weight that can be placed on, carried by, or towed by the standard trailer hitch receiver (“receiver(s)”). By virtue of the use of said standard receivers and by the use of a mobile jack rack designed to hold and support various components (“components”), including but not limited to tailgating equipment (“tailgating equipment”), tailgating becomes possible for many additional people, including those without trucks and/or trailers, and further, anybody can tailgate with considerably less work and effort. Even one person will be able to haul a considerable amount of heavy tailgating equipment if it is situated on a mobile jack rack. Mobile jack racks insert into standard receivers and support tailgating equipment, including but not limited to, gas and/or charcoal BBQ pits (“BBQ pit(s)”), electric and/or gas boilers and cookers (“boiler/cooker(s)”), electric and/or gas appliances such as ovens, microwaves, refrigerators, freezers and the like, collectively (“appliance(s)”), electric entertainment items including but not limited to TVs, DVDs, game machines, streaming media players, and the like (“entertainment equipment”), all aforementioned herein collectively referred to as either (“tailgating equipment”), or collectively herein included in the (“tailgating system”). For extra heavy or awkward tailgating equipment, a heavy-duty mobile jack rack, designed to clamp down, by using a proprietary nut and bolt feature (“clamp”), on the hook flaps that protrude on both sides of the typical receiver for balance and/or additional weight support, said heavy duty mobile jack rack herein included in the description of mobile jack rack or mobile jack rack system. Descriptions of some tailgating equipment such as the collapsible BBQ pit, that can be built onto a mobile jack rack as a single unit, or that can be separately placed and secured on it are as follows.

FIG. 7 illustrates block diagram of an inside, collapsed view of an article of manufacture for providing a mobile jack rack featuring a collapsible BBQ pit and smoker in its transporting state, according to the present invention. A special, full sized BBQ Pit 601, designed to collapse into a size that fits onto a mobile jack rack for mobility, with parts and extensions 602a-b that store inside the main body for compactness. To make ready for use, parts and extensions 602a-b are removed from inside the main body 701, then attached to said main body 701 creating a full-size system BBQ pit 601. The system BBQ pit can either be used connected to the vehicle with heat shields or removed from the vehicle using the scissor jack on the mobile jack rack to lower the locking wheels onto the ground or other surface. The system BBQ pit can either be operated with propane that is also positioned on the mobile jack rack, or with charcoal.

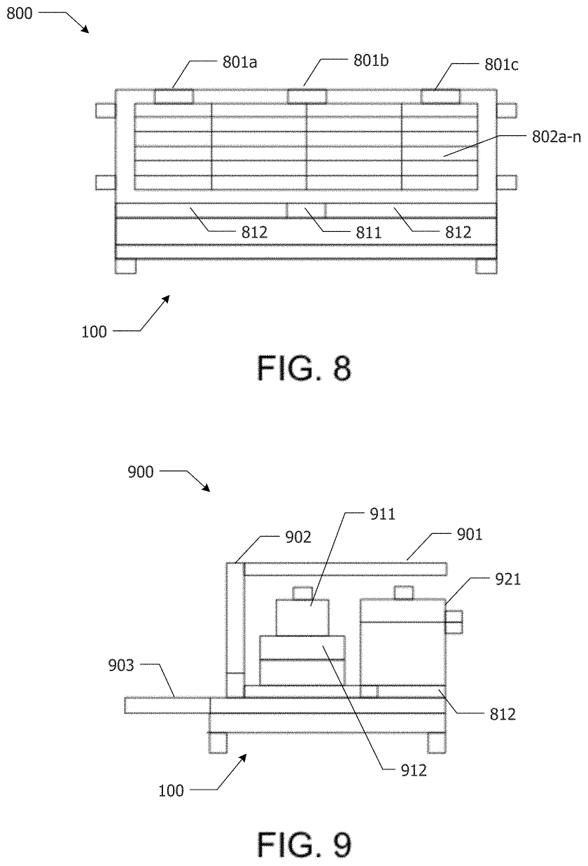

FIG. 8 illustrates block diagram of a rear view of an article of manufacture for providing a mobile jack rack collapsible BBQ pit in a closed position, with hooks 801a-c and the like to hang utensils according to the present invention. One or more utensil storage locations 802a-n are on the rear of the tailgating equipment 800 consisting of a storage rack that is mounted onto a mobile jack rack 100. A set of utensil hooks 801a-c may be located along a top edge of the storage rack 800 above the storage locations 802a-n. The entire storage rack 800 rests on top of a frame 812 that couples to the upper support platform 101 of the mobile storage rack 100. A hitch tongue or tow bar 811 attaches to the frame 812 for attachment to a vehicle towing hitch receiver.

Similarly, FIG. 9 illustrates block diagram of a side view of an article of manufacture for providing a mobile jack rack 100 used as a collapsible BBQ pit and smoker 900 with the propane tank 911, lighting 901, heat shield 902, tow bar 903, and BBQ pit and smoker in collapsed position 921 according to the present invention. The propane tank 911 rests on top of a slide out cooktop burner 912. A base BBQ pit rests on top of the frame 812 and the mobile jack rack 100.

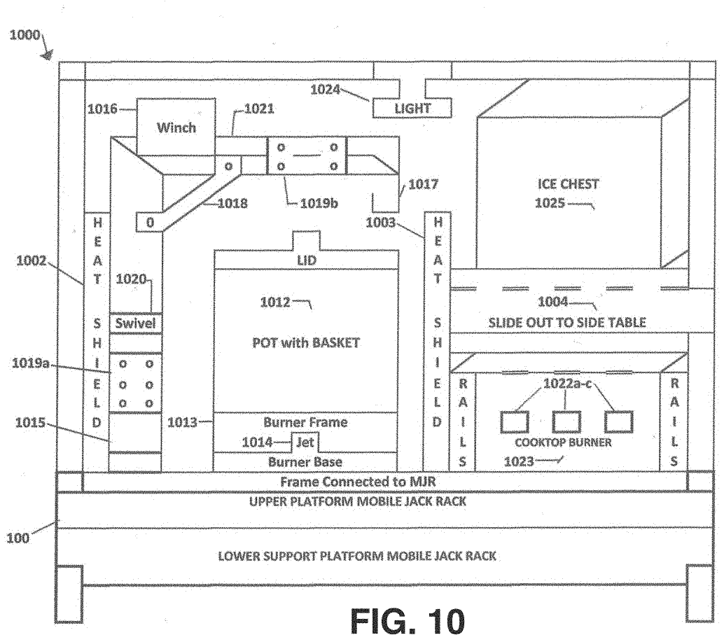

FIG. 10 illustrates block diagram of front view of an article of manufacture for providing a mobile jack rack 100 used as a tailgating boiler pot 1012, cooktop 1023, and hoist 1015 according to the present invention. The tailgating boiler pot 1012 rests on top of a burner 1013 and jet 1014 where the hoist 1015 is positioned above the tailgating boiler pot 1012, said hoist is height adjustable by an adjusting section 1019a, having an extending adjustable arm by an adjusting section 1019b, and swivels by virtue of a swivel 1020 on the hoist post to be able to remove the boiling pot 1012 from the burner 1013 and set it on the ground or wherever. Said hoist also has a winch 1016 and a cable 1017. When said hoist is positioned for use, its post and arm 1021 are supported by a brace 1018, and when said brace 1018 is removed, said arm 1021 folds down against said post 1015. Said system 1000 is lighted up with an LED light 1024 powered by the vehicles electric plug or by battery. The tailgating boiler pot 1012 is placed between a pair of wind and heat shields 1002-1003. A slide out table 1004 and ice chest 1025 may be positioned on the opposite side of the boiling pot 1012 and the heat shield 1003. Up to 3 burners 1022a-c may rest below the slide out table 1004 and ice chest 1025 and on top of a cooktop 1023 for use while tailgating.

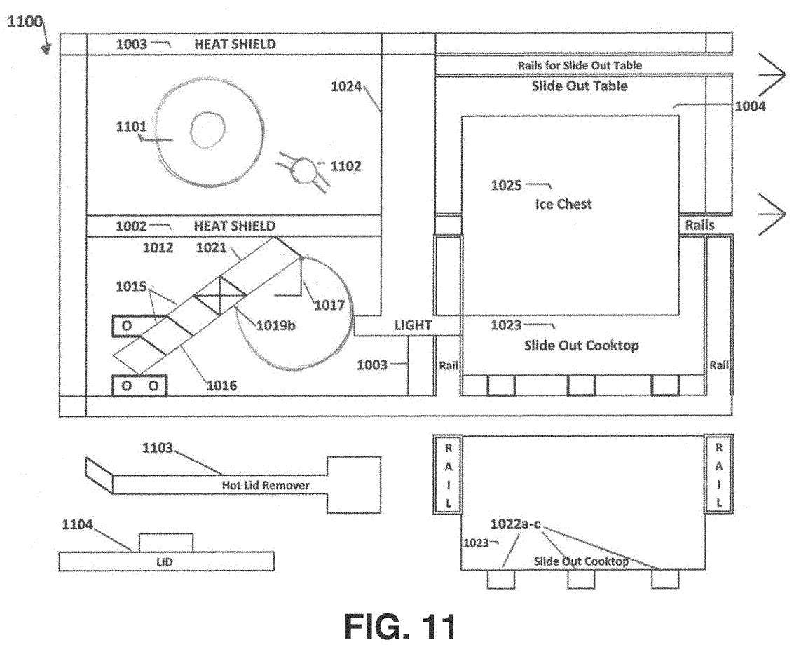

FIG. 11 illustrates block diagram of a top view of an article of manufacture for providing a mobile jack rack used as a tailgating boiler pot 1012, cooktop 1023, and hoist 1015 according to the present invention. A full-sized propane tank 1101 with a regulator 1102 to fuel the burner 1013, jet 1014 and cooktop 1023. Said burner 1013 and jet 1014 for boiling things such as crabs, shrimp, crawfish, and the like in a large boiling pot 1012, combined with a slide out gas burner cooktop 1023 with multiple cooking burners 1022a-c (“system boiler/cooker”). Said system boiler/cooker 1000 can be custom built on or placed onto a mobile jack rack 100 and can be used while hitched to the vehicle with heat shields 1002-1003, or it can be detached, moved all around by virtue of wheels, and used free standing. An accessory bar 1103 permits a lid 1104 to the boiler/cooker 1012 to be removed out of the user's way.

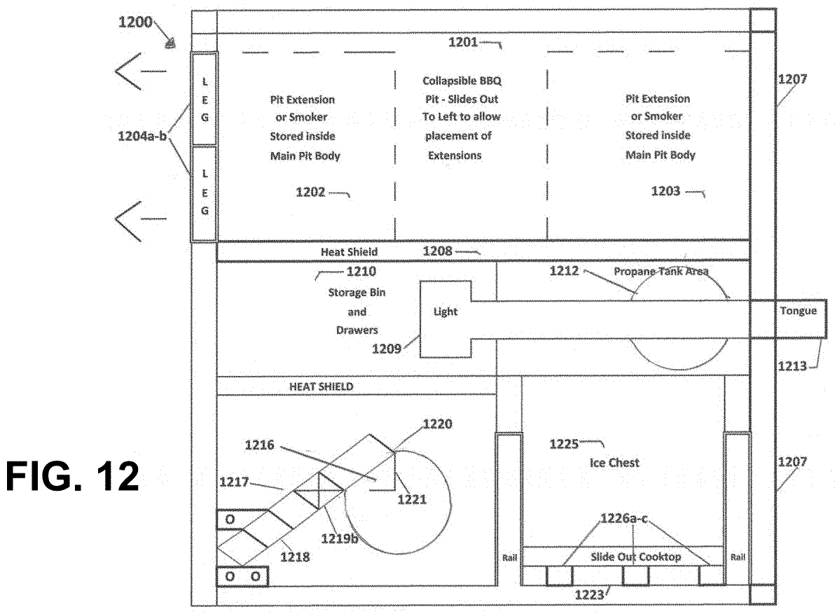

FIG. 12 illustrates block diagram of a top view of an article of manufacture for providing a mobile jack rack used as a combination BBQ pit, boiler, pot, cooktop, and hoist 1200 whereby each are operated from the sides of the mobile jack rack. The collapsible BBQ pit 1201 slides out toward the front far enough to attach any extensions 1202-1203 to said collapsible BBQ pit. For support when slid out, folding support legs 1204a-b are folded down to the ground surface. A heat shield 1207 is situated at the rear of the rack to shield any vehicle from heat in the event the tongue 1213 is still inserted into the vehicle receiver, and a heat shield 1208 is situated in between said collapsible BBQ pit and the remaining items on the rack. A light 1209 extends from the rear, and a storage bin with drawers 1210 is situated in the front of said combination BBQ pit, boiler, pot, cooktop, and hoist 1200. The propane tank 1212 is the power source for the boiler and cooktop 1223 and the BBQ pit 1201 if desired. The boiler side has a height adjustable, swiveling hoist with an extended arm 1217 with a winch 1218 and an adjustable section 1219 with a cable 1221 that rolls over a roller 1220 if needed to pickup any pot, basket and/or lid to swivel and move either to the ground or other surface. There is a slide out cooktop 1223 with multiple burners with adjusting knobs 1226a-c for pot cooking, and an area above said cooktop 1223 for an ice chest 1225 or whatever.

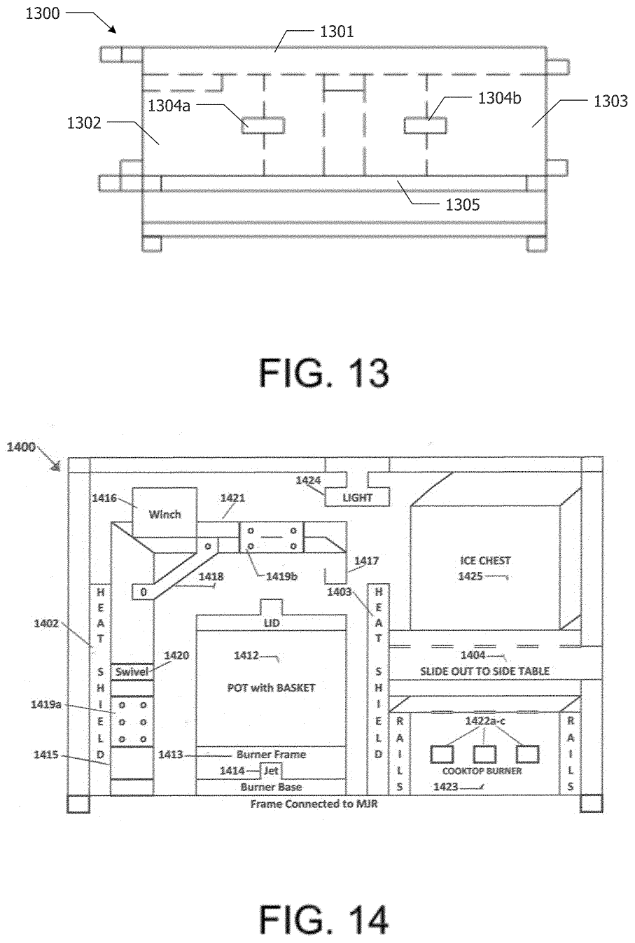

FIG. 13 illustrates block diagram of an inside view of an article of manufacture for providing a mobile jack rack 100 used as BBQ pit side of a combination BBQ pit, boiler, pot, cooktop, and hoist 1200 according to the present invention. An opening lid 1301 is secured to the combination BBQ pit, boiler, pot, cooktop, and hoist 1200 by a pair of latches 1304a-b. Within the combination BBQ pit, boiler, pot, cooktop, and hoist 1200, a smoker box 1302 may be stored within the combination BBQ pit, boiler, pot, cooktop, and hoist 1200 on one side, and a pit extension 1303 may be stored on the other side of the combination BBQ pit, boiler, pot, cooktop, and hoist 1200. A propane or charcoal cooking grid 1305 that runs along the inside bottom of the combination BBQ pit, boiler, pot, cooktop, and hoist 1200.

Similarly, FIG. 14 illustrates block diagram of a side view of an article of manufacture for a mobile jack rack 100 used as a tailgating boiler pot 1412, cooktop 1423, and hoist 1415 of a combination BBQ pit, boiler, pot, cooktop and hoist according to the present invention. The tailgating boiler pot 1412 rests on top of a burner 1413 with a jet 1414 where the hoist 1415 is positioned above the tailgating boiler pot 1412. Said hoist 1415 is height adjustable on its post, and length adjustable on its extending arm by adjusting the adjustable sections 1419a-b, and said hoist swivels by virtue of its swivel 1420 to be able to remove the boiling pot 1412 from the burner 1413 and set it on the ground or wherever. Said hoist also has a winch 1416 and a cable 1417. When said hoist 1415 is positioned for use, its post and arm are supported by a brace 1418, and when said brace 1418 is removed, said arm folds down against said hoist post. Said system 1400 is lighted with an LED light 1424 powered by the vehicles electric plug or by battery. The tailgating boiler pot 1412 is situated between a pair of wind and heat shields on each side 1402-1403 along with one in the rear. An ice chest 1425 may be placed on the opposite side of the boiling pot 1412 and heat shield 1403. Up to 3 burners 1422a-c may rest below the ice chest 1425 on top of a cooktop 1423 for use while tailgating.

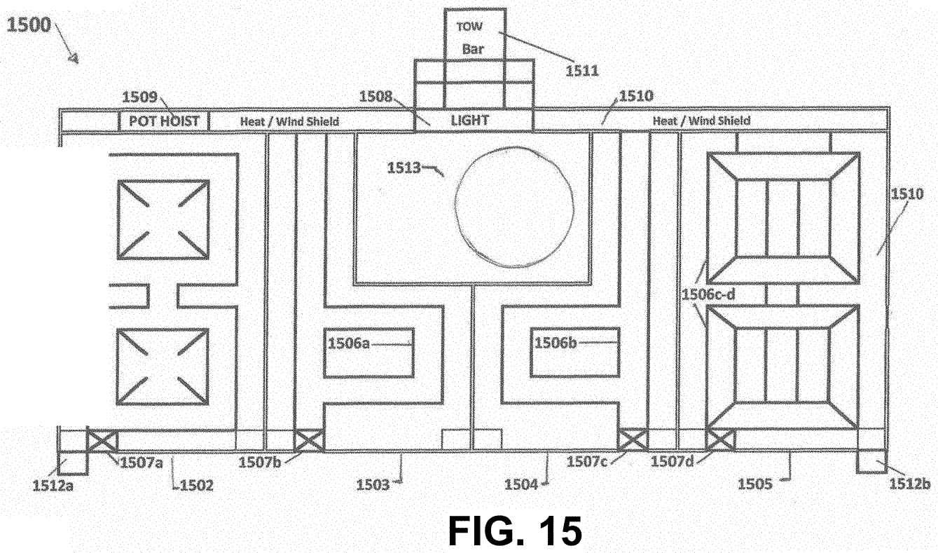

FIG. 15 illustrates block diagram of an article of manufacture for providing a mobile jack rack 100 used as a system cooking rack with interchangeable components 1500 according to the present invention. The system cooking rack with interchangeable components 1500, as one possible layout, includes a set of interchangeable cooking components comprised of a double boiler 1502, a left hand griddle 1503, a right hand griddle 1504 and a double burner 1505. Each individual component has heat adjusting knobs 1507a-d, controlling the electric or gas heating coils 1506a-d powered by either propane, solar panels or battery packs, all comprising the power system 1513. Said system cooking rack 1500 has heat and wind shields 1510a-b, a light 1508, a stand for an optional pot hoist 1509, taillights 1512a-b, and a hitch tow bar 1511. Other interchangeable heat type components able to be situated into said interchangeable cooking rack 1501 include but are not limited to a left hand boiler 1601, a right hand boiler 1602, a left hand burner 1701, a right hand burner 1702, a full griddle 1801 and an open component 1900 for cooking. Said interchangeable components each have individual heat adjusting knobs.

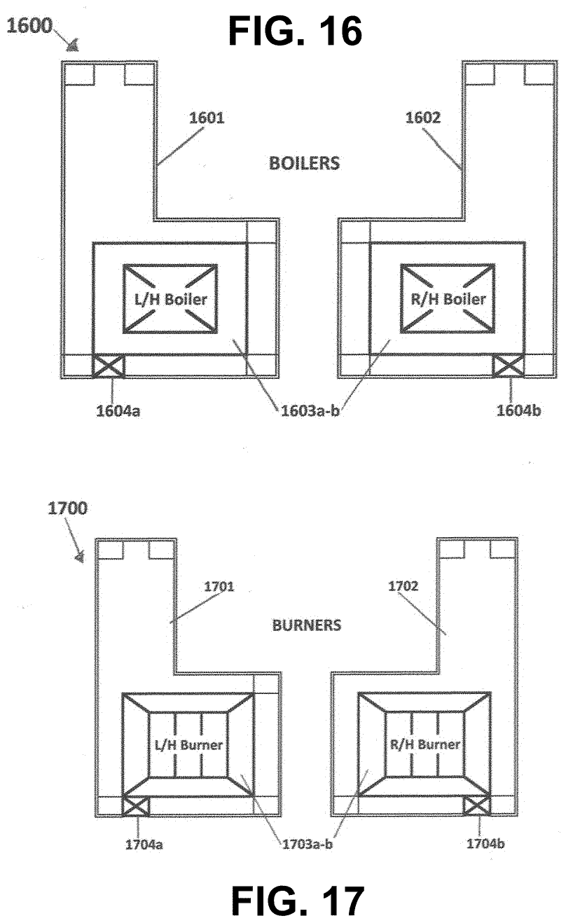

FIG. 16 illustrates block diagram of an article of manufacture for providing a mobile jack rack 100 used as one embodiment of a system cooking rack 1600 with interchangeable components including but not limited to a left hand boiler 1601, and a right hand boiler 1602 according to the present invention. Said interchangeable components, left hand boiler 1601 and right hand boiler 1602, each having electric or gas heating coils 1603a-b, and heat adjusting knobs 1604a-b. Similarly, FIG. 17 illustrates block diagram of an article of manufacture for providing a mobile jack rack 100 used as another embodiment of a system cooking rack 1700 with interchangeable components including but not limited to a left hand burner 1701 and a right hand burner 1702, according to the present invention. Said interchangeable component a left hand burner 1701 and a right hand burner 1702 each having electric or gas heating coils 1703a-b, and heat adjusting knobs 1704a-b.

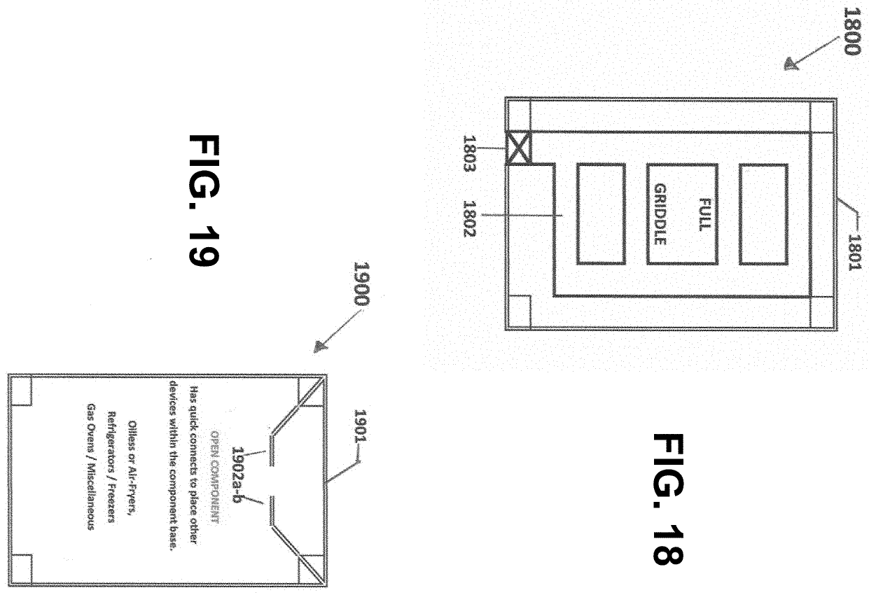

FIG. 18 illustrates block diagram of an article of manufacture for providing a mobile jack rack 100 used as yet another embodiment of a system cooking rack 1800 with an interchangeable component being a full griddle 1801 according to the present invention. Said interchangeable component a full griddle 1801 has electric or gas heating coils 1802, and a heat adjusting knob 1803.

FIG. 19 illustrates block diagram of top view of an article of manufacture for providing a mobile jack rack 100 used as another embodiment of a system cooking rack 1900 with an open interchangeable component able to power other miscellaneous appliances that can be situated on said open component 1901, powered by quick connects 1902a-b attached to the power system. Various appliances and the like that can be situated upon said open component 1900 including but not limited to an oilless and/or air fryers, mini refrigerators, mini freezers, ovens and the like.

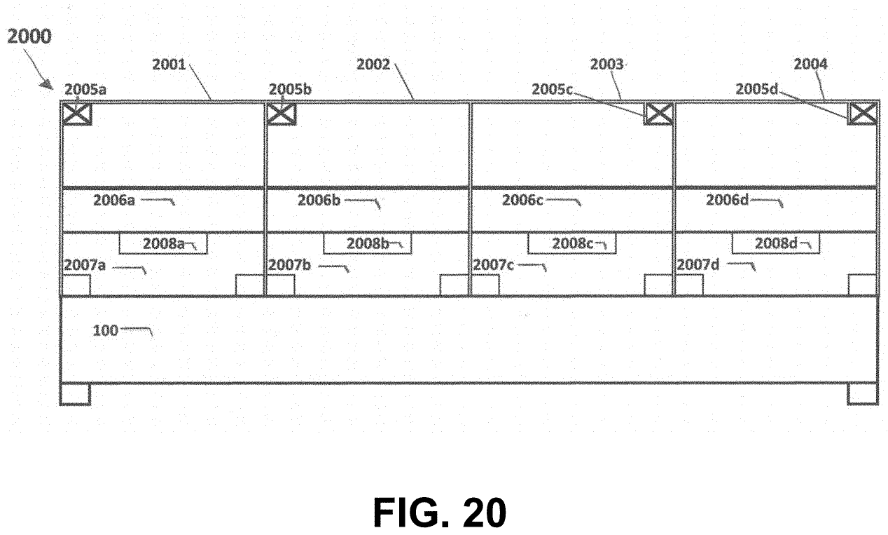

FIG. 20 illustrates block diagram of a front view of an article of manufacture for providing a mobile jack rack 100 used as another embodiment of an interchangeable cooking component system rack 2000 with interchangeable components according to the present invention. Said interchangeable components 2001-2004 may be any combination of interchangeable components with different heat types and power sources, including but not limited to a double boiler 1502, a left hand boiler 1601, a right hand boiler 1602, a double burner 1505, a left hand burner 1701, a right hand burner 1702, a full griddle 1801, a left hand griddle 1503, a right hand griddle 1504, and an open component 1900 for cooking. Said interchangeable components each have heat adjusting knobs 2005a-d, and said interchangeable components 2001-2004 each include a separate vertical arrangement of components including a heat buffer 2006a-d, a storage drawer 2007a-d, and drawer handles 2008a-d.

A mobile jack rack 100 with built in gas and electric connections, designed to accept various universally sized components such as electric and/or gas griddles, boilers, burners, ovens, microwaves, appliances, or other functional components (“system components”) that fit into universally sized sections of a particular mobile jack rack. Said particular mobile jack rack 100 is designed to hold up to 4 universally sized system components, and any can be changed out or switched out at any time, allowing total flexibility in any tailgating and/or special event function.

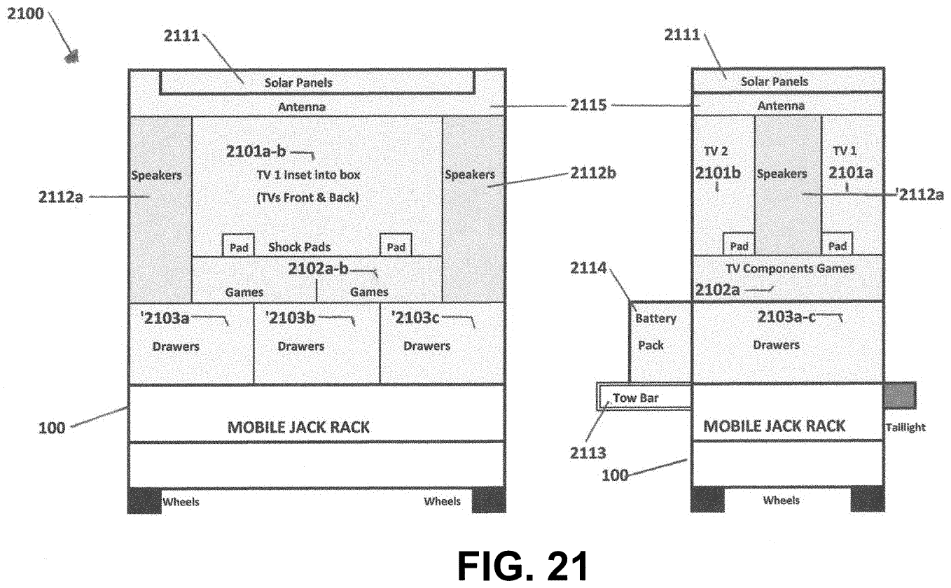

FIG. 21 illustrates block diagram of an article of manufacture for providing a mobile jack rack 100 used as a system entertainment center 2100 according to the present invention. Various items such as TVs 2101a-b with antennas 2115, game machines, DVDs and the like situated in component compartments 2102a-b, with speakers 2112a-b used for entertainment (“system entertainment components”) can be taken anywhere by a regular vehicle using the mobile jack rack. One or more storage drawers 2103a-c may be included to hold other accessories and items used with the system entertainment components. The system entertainment components can be contained into a single cabinet, powered by solar panels 2111, the hitch plug, a splitter plug or battery pack 2114 or a combination of any, and said single cabinet may be custom built, or separately placed onto the mobile jack rack.

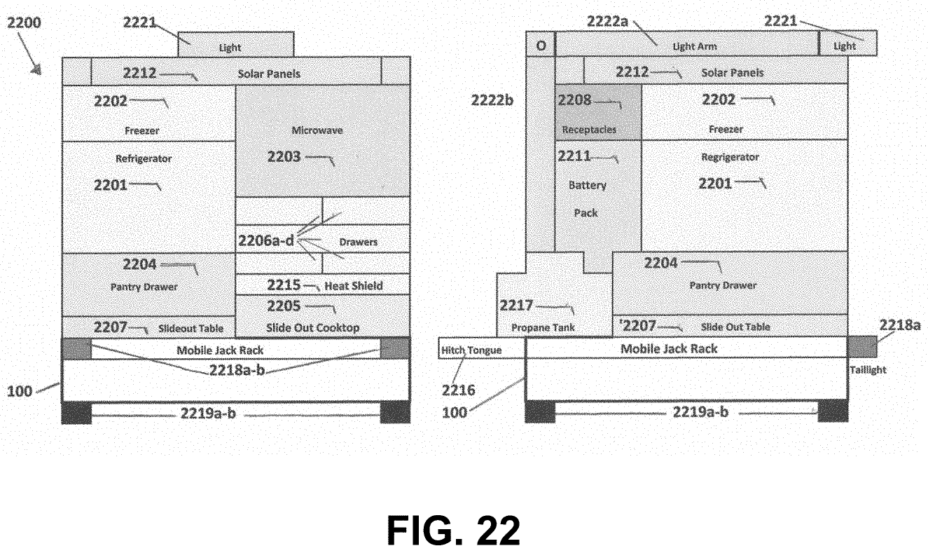

FIG. 22 illustrates block diagram of a front view and a side view of an article of manufacture for providing a mobile jack rack 100 used as system mobile travel center 2200 according to the present invention. One of many possible configurations of items such as a refrigerator 2201, freezer 2202, microwave 2203, electric and/or gas cooktop 2205, utensil drawers 2206a-e, pantry drawers 2204 and the like, along with a slide out table 2207, along with 110 and 220 receptacles 2208 for coffee pots, crock pots, rice cookers and the like along with USB ports 2208, all custom situated on a mobile jack rack 100 to fit any particular application, fitted with a splitter plug, a battery pack 2211, solar panels 2212, and/or a propane tank 2217, setup with “quick-connects” for gas and/or electricity that enables a typical vehicle to bring any combination of the aforementioned to any destination, whether to an event, party or game, or a long vacation trip or whatever. Said travel center is efficient and economical due to being able to eliminate eating out while at events or traveling away from home, especially if a family is involved. Said travel center is wired internally with security alarms, flashing lights and other alarm features and has strategically placed iron loops attached to the frame of said travel center so that additional security can be had by using a light duty chain connected to the vehicle rear frame. Said travel center can be used with heat shields 2215 while attached to the vehicle or detached and moved around on said mobile jack rack's wheels. Said system mobile travel center 2200 situated on a mobile jack rack with a tongue 2216 to insert into a vehicle's receiver, a battery pack 2211 and taillights 2218a-b. One or more light arms or posts 2222a-b and lights 2221 complete the system mobile travel center 2200.

There are many types of work and/or projects that require specialized tools and/or specialized equipment, and a great deal of said specialized tools and/or specialized equipment requires a truck and/or trailer to be hauled around. Although components can be bought separately and placed on and secured onto a mobile jack rack 100, this utility equipment component system is designed to have specialized tools and/or certain specialized equipment (“specialized equipment”) built onto mobile jack racks, creating an equipment component (“equipment component system”), that can be inserted into a vehicle's standard hitch receiver (“receiver(s)”) to be able to be hauled around and used anywhere, collectively included in the (“utility equipment system”).

The main restriction is the weight of the equipment component. Depending on the Class of Vehicle, and the Class of the Hitch, determines the weight carrying capacity (“carrying weight”) and towing weight of the particular vehicle, the typical range of carrying weight, depending on vehicle and receiver class ranges from 300 pounds to 1100 pounds, but any equipment component within the weight restrictions would be able to be hauled and used.

The following are detail descriptions of some, but not all equipment components that can be supported by mobile jack racks that have taillights and locking, swiveling wheels or rubber tires underneath, that comprise the overall utility equipment system. All equipment components can be used attached to the vehicle by the receiver, although some would require the mobile jack rack to be in the open position so that the lower support base with wheels can be situated on the ground or surface to be able to offer additional support for balance and weight, and all equipment components can be detached from the vehicle, moved around, stored, or used anywhere.

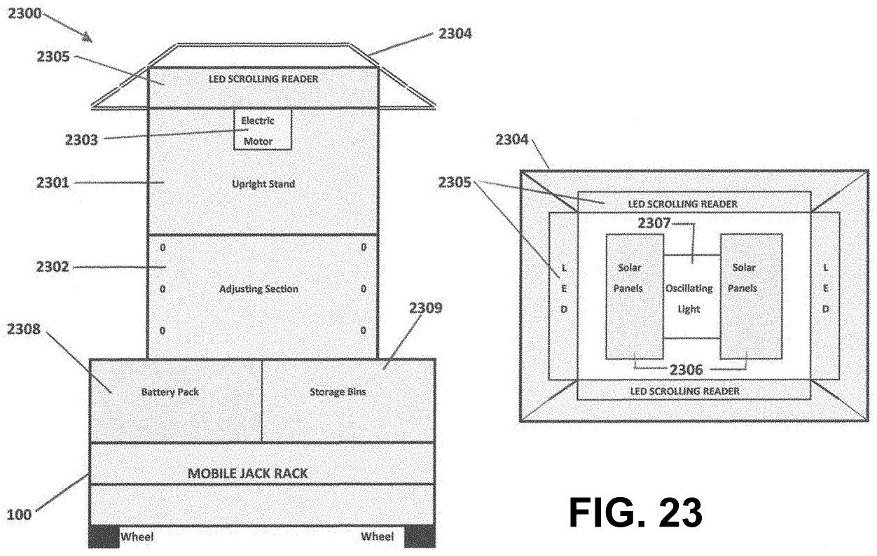

FIG. 23 illustrates block diagram of an article of manufacture for providing a mobile jack rack 100 used as a 4 sided, rotating, LED scrolling reader board 2300 for various uses according to the present invention. An LED scrolling reader board with an adjustable main post 2301-2302, an electric motor 2303, a plexiglass container 2304 containing 4 scrolling LED reader boards 2305a-d, solar panels 2306 and an oscillating light 2307. Said LED scrolling reader board 2300 has a battery pack 2308 charged by either solar panels 2306, ac power, trailer light plug, or a splitter plug, along with storage bins 2309, all situated on a mobile jack rack 100 with locking wheels underneath, taillights and a hitch tongue that inserts into a standard receiver for towing.

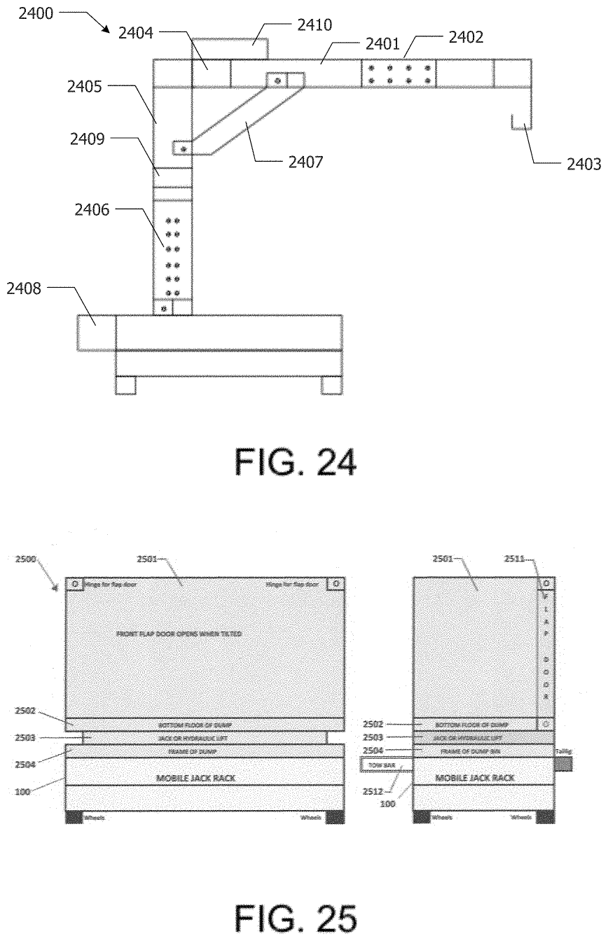

FIG. 24 illustrates an additional block diagram of side view of an article of manufacture for providing a mobile jack rack 100 used as system single arm hoist 2400 according to the present invention. A collapsible, folding hoist (“hoist”) with a telescoping hoist post 2405-2406 for height, and an adjustable extending arm 2401-2402, and a manual or electric winch 2410 with cable 2403, and a swivel 2409 to allow said hoist post 2405 to swivel, situated on a mobile jack rack 100 with locking wheels underneath, taillights and a hitch tongue 2408 that inserts into a standard receiver for towing. Said hoist's adjustable extending arm swings side to side by virtue of said swiveling, telescoping hoist post 2405, that, when in use and supported by support legs, is capable of loading or unloading a truck or trailer by lifting as much or more than a ton (2,000 pounds). The system single arm hoist 2400 includes a removable arm brace 2407 that attaches to said hoist post 2405 and said extending arm 2401.

FIG. 25 illustrates block diagram of front and side view of an article of manufacture for providing a mobile jack rack 100 used as system hydraulic/manual dump bin 2500 according to the present invention, having a holding bin 2501, with a bin floor 2502 situated on a manual or hydraulic lifting jack 2503, further situated on a frame 2504, also having a front flap 2511 that opens when tilted, all situated on a mobile jack rack 100 with wheels underneath, taillights and a tow bar 2512 that inserts into a standard receiver. Said system hydraulic/manual dump bin 2500 can be loaded with mulch, dirt, sand, or the like, within weight restrictions of the vehicle and/or receiver, then hauled and dumped with minimal effort. Dumping can be by manual crank or by hydraulic lifters 2503.

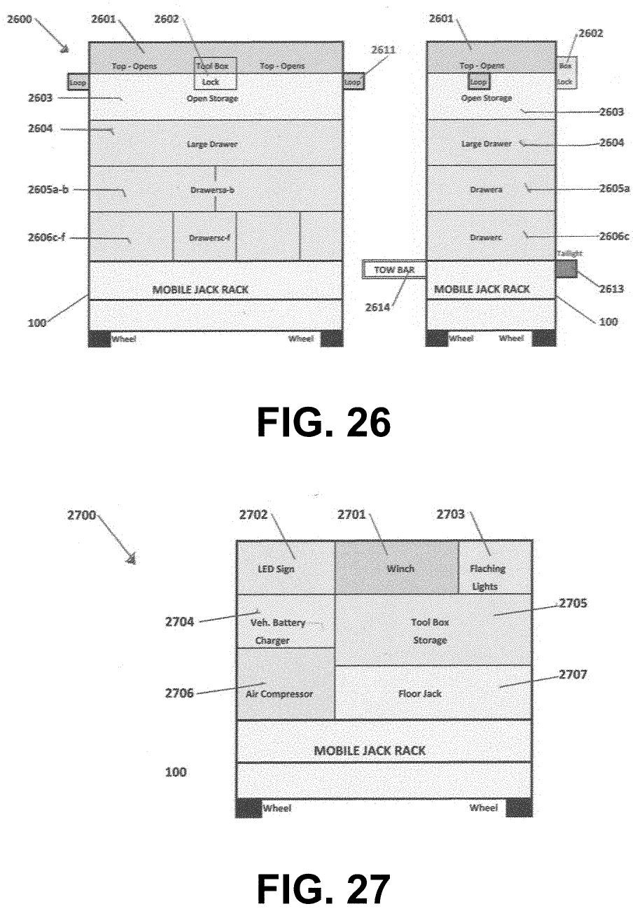

FIG. 26 illustrates block diagram of front and side view of an article of manufacture for providing a mobile jack rack 100 used as system mobile toolbox 2600 according to the present invention. A regular toolbox (“toolbox”) 2600 positioned on a mobile jack rack 100 with wheels underneath and taillights 2613, that, within weight restrictions, can be hauled anywhere by using the standard receiver of a vehicle by inserting the mobile jack rack's tow bar 2614 into said standard receiver. As one of many possible configurations, the toolbox 2600 includes a toolbox lid 2601 that covers two elongated storage containers situated one on top of the other 2603-2604. Said toolbox lid 2601 is secured to the toolbox 2600 by a toolbox lock 2602. The toolbox 2600 also contains a plurality of tool drawers 2605a-b and 2606c-f. The toolbox 2600 can be easily moved to remote locations or can be used for typical home or shop use, either while attached or detached from the vehicle.

FIG. 27 illustrates block diagram of front view of an article of manufacture for providing a mobile jack rack 100 used as system emergency road package 2700 according to the present invention. A customized layout of emergency use items positioned on a mobile jack rack 100 with wheels underneath and taillights, that, within weight restrictions, can be hauled anywhere by using the standard receiver of a vehicle by inserting the mobile jack rack's tow bar into said standard receiver. One possible layout of said emergency road package 2700 comprises a collection of items such as a vehicle battery charger 2704, an air compressor 2706, a tool box 2705, a floor jack 2707, a winch 2701, an LED scrolling sign 2702, LED flashing lights 2703, and other possible emergency tools and/or equipment that can be situated on a mobile jack rack 100 and powered by solar panels, battery packs, the hitch plug, or a splitter plug.

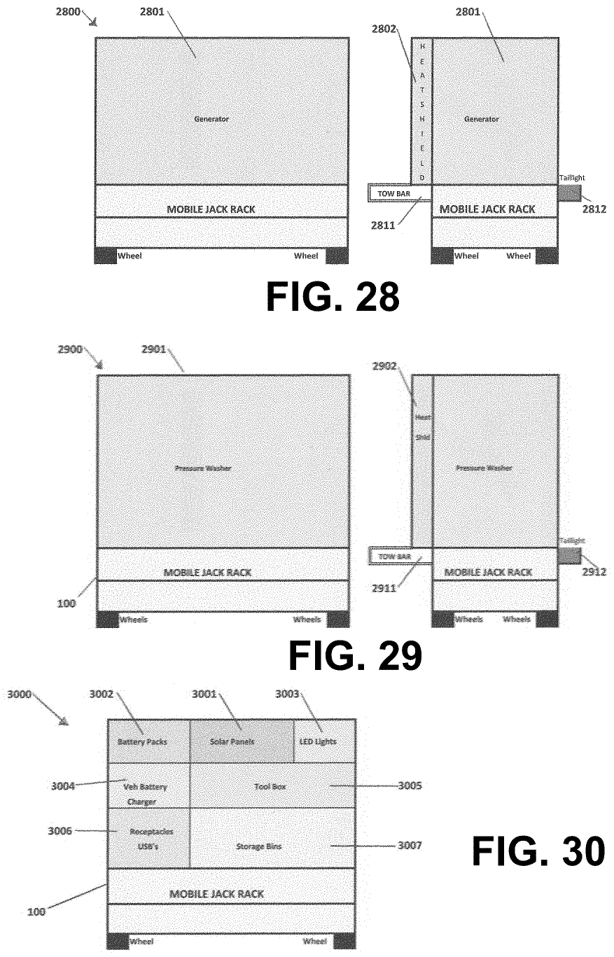

FIG. 28 illustrates block diagram of a front and side view of an article of manufacture for providing a mobile jack rack 100 used as system mobile generator 2800 according to the present invention. A generator positioned on a mobile jack rack 100 with wheels underneath and taillights, that, within weight restrictions, can be hauled anywhere by using the standard receiver of a vehicle by inserting the mobile jack rack's tow bar into said standard receiver. A generator 2801 having a heat shield 2802 is coupled to the upper support platform 101. A tow bar 2811 and taillights 2812 are also coupled to the upper support platform 101 for use when being towed.

FIG. 29 illustrates block diagram of front and side view of an article of manufacture for providing a mobile jack rack 100 used as system mobile pressure washer 2900 according to the present invention. A pressure washer 2901 built onto a mobile jack rack 100 with wheels underneath and taillights 2912, that has a tow bar 2911 that inserts into the vehicle receiver allowing a vehicle to transport said pressure washer 2901 anywhere, thus, an easy, mobile pressure washer. Said pressure washer can be used attached to the vehicle with heat shields 2902 or can be detached and used as a home or shop pressure washer.

FIG. 30 illustrates block diagram of front view of an article of manufacture for providing a mobile jack rack 100 used as system mobile power supply 3000 with solar panels 3001, battery packs 3002, LED lights 3003, battery charger 3004, tool box 3005, 110 and 220 receptacles 3006, and storage bins 3007 according to the present invention. A containerized power supply 3000 situated on a mobile jack rack 100 with taillights and wheels. Said battery pack 3002 is charged by either, or, a combination of the trailer light plug, solar panels, the hitch plug or the splitter plug.

Even though particular combinations of features are recited in the present application, these combinations are not intended to limit the disclosure of the invention. In fact, many of these features may be combined in ways not specifically recited in this application. In other words, any of the features mentioned in this application may be included to this new invention in any combination or combinations to allow the functionality required for the desired operations.

No element, act, or instruction used in the present application should be construed as critical or essential to the invention unless explicitly described as such. Further, the phrase “based on” is intended to mean “based, at least in part, on” unless explicitly stated otherwise.

What is claimed is:

1. An article of manufacture for providing a mobile jack rack supporting a plurality of uses, the mobile jack rack comprises:
a tow bar for coupling to a vehicle trailer towing receiver;
an upper support platform having a front side coupled to the tow bar and a plurality of sliding support flanges coupled to an upper side;
a manual scissor jack coupled to an underside of the upper support platform, the manual scissor jack having a manual hand crank;
a lower support base having a top side coupled to an opposite side of the manual scissor jack;
a steering bar hinge coupled between the manual hand crank and the manual scissor jack to position the manual hand crank in an orientation allowing the manual hand crank to be used as a steering bar;
a plurality of locking wheels coupled to an underside of the lower support platform; and
a component coupled to the plurality of support flanges.

2. The mobile jack rack according to claim 1, wherein the plurality of locking wheels comprise one of the following: rubber tires and swiveling wheels.

3. The mobile jack rack according to claim 2, wherein the manual hand crank further adjusts a position of the lower support base within a perimeter of inches.

4. The mobile jack rack according to claim 3, wherein the component comprises one or more of the following: a generator, a toolbox, a pressure washer, a tailgating equipment boiler/cooker, appliances, entertainment equipment, and safety equipment.

5. The mobile jack rack according to claim 4, where in the mobile jack rack further comprises a mobile jack rack receiver coupled to a back side of the lower support platform for accepting a tow bar attached to an additional trailerable device.

6. The mobile jack rack according to claim 4, wherein the tailgating equipment comprises one or more of the following: gas and/or charcoal BBQ pits, electric and/or gas boilers, and cookers.

7. The mobile jack rack according to claim 4, wherein the appliances comprise one or more of the following: electric and/or gas appliances such as ovens, microwaves, refrigerators, and freezers.

8. The mobile jack rack according to claim 4, wherein the entertainment equipment comprises one or more of the following: TVs, DVDs, game machines, and streaming media players.

9. The mobile jack rack according to claim 4, wherein the upper support platform further comprises a tow receiver for accepting a tow bar from another trailer.

10. The mobile jack rack according to claim 4, wherein the safety equipment comprises one or more of the following: a 4 sided LED scrolling reader board, a single arm hoist, a system mobile generator, a system mobile power supply, a system emergency road package.

11. The mobile jack rack according to claim 4, wherein the system mobile power supply comprises one or more of the following solar panels, battery packs, AC chargers, battery chargers, lighting, and receptacles.

12. The mobile jack rack according to claim 4, wherein the system emergency road package comprises one or more of the following: an air compressor, a battery charger, a floor jack, a small toolbox, a winch, an LED scrolling sign, an LED flashing light stand.

13. The mobile jack rack according to claim 4, wherein the component further comprises a system dump bin, the system dump bin comprises:
a storage bin having a bin floor and an opening front flap; and
a bin dumping lifter for raising and tilting the storage bin for emptying contents.

14. The mobile jack rack according to claim 13, wherein the bin dumping lifter comprises a manual lifter and a hydraulic lifter.
